(19) United States
(12) Patent Application Publication
(10) Pub. No.: US 2011/0173105 A1
(43) Pub. Date: Jul. 14, 2011

(54) Utilizing AAA/HLR infrastructure for Web-SSO service charging

(75) Inventors: Achill Schirilla, Munich (DE); Silke Holtmanns, Klaukkala (FI); Hannes Tschofenig, Espoo (FI)

(73) Assignee: Nokia Corporation

(21) Appl. No.: 12/655,909

(22) Filed: Jan. 8, 2010

(51) Int. Cl. H04L 9/32; G06Q 30/00; G06Q 50/00

(52) U.S. Cl. 705/34; 705/318; 726/9; 713/176

(57) ABSTRACT

An apparatus (such as a AAA node of a core/operator network) receives from a relying party an initial credit control request that bears first information comprising a relying party identifier, a service context identifier for a service to be provided by the relying party, and a token that authenticates a subscriber. The first information is extracted and forwarded to a core network accounting server that stores account information for the subscriber. The relying party is not within the core network. In reply to forwarding the extracted first information, the apparatus receives from the accounting server a credit control answer that bears second information comprising the relying party identifier, the service context identifier, and a grant indicating the subscriber may be charged a fee for the service to be provided by the relying party. The second information is extracted and forwarded to the relying party.

### TECHNICAL FIELD

The exemplary and non-limiting embodiments of this invention relate generally to interfacing between a subscriber network and an open network for coordinating charges to a subscriber, for example charging a subscriber's core network account for content provided by an Internet service provider.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

AAA authentication, authorizing and accounting

AKA authentication and key agreement

CC credit control

CCA credit control answer

CCR credit control request

GBA generic bootstrapping architecture

GSM global system for mobile telecommunication

HLR home location register

HSS home subscriber service

IdP identity provider

OpenID an open, decentralized standard for authenticating users

RAN radio access network

RP relying party

SAML security assertion markup language

SSO single sign-on

UE user equipment

UMTS UTRAN mobile telecommunication system

UTRAN universal terrestrial radio access network

WLAN wireless local area network

Apart from secure sites, the Internet is generally comprised of open servers, accessible to all corners. Fee based products and services (for example: downloads of games, music or video; access to fee-based content; and online purchases of physical goods to be shipped) are often paid by traditional means: the prospective buyer entering charging information at a web page of the prospective seller, in which the charging information may be for example credit card information, or pre-existing account information that already includes the card information. The prospective buyer then authorizes the charge.

Mobile user equipment such as mobile phones/terminals and other personal communication devices connect to their home operator or core network via a wireless radio access network. The core network can provide further connection to the Internet. The core network maintains the mobile user terminal's identity at a home location register HLR or an AAA server, and maintains its charging account information at some accounting/charging node. At least the HLR or AAA server is used to authenticate the terminal anytime it seeks to establish a wireless connection, regardless of the terminal's physical location or RAN involved. There may be different names for this same HLR/AAA functionality in different wireless systems; AAA and HLR are two common examples. Authenticating the terminal enables it to roam seamlessly across different RANs, which generally charge one another for various access services they provided to the terminal.

It would be convenient for a user operating his/her terminal to have a single sign-on SSO for Internet applications, particularly world wide web applications in which there is some fee for service which the user would like to access. To maintain this exchange as an SSO would entail sharing information about the terminal between the core network that stores the terminal-specific information and the web server which provides the online service (download or access) for the terminal. But current WebSSO solutions were not designed to enable off-line accounting or real-time credit control. Also, the existing AAA/HLR processes in the core networks were designed to enable allocation of access charges among RANs, all of whom are connected to their own core networks which share similar security concerns that are not necessarily shared by Internet fee-for-service sites. A web-SSO solution might also fill a need for enabling online purchases in certain developing markets, where for example the majority of consumers may not have easy access to a banking payment infrastructure/credit cards.

It does not appear that the Internet web service providers have sufficient interest to support complex telecommunication-specific protocols and interfaces to enable such a web-SSO, since they can simply use their existing charging methods which the terminal users enter manually (for example, PayPal or credit card account information).

The existing accounting and charging backend infrastructure of mobile system core networks might be integrated with the more diverse universe of internet-based service providers, but to offer Web-SSO solutions for identity and attribute sharing would require investments by the mobile network operators to ensure security of their subscriber data. The core network operators can possibly recoup their related development and operational costs by charging for the web-service that is provided to the terminal via such an integrated web-SSO arrangement. But core network operators generally do not want outside entities to have access to their AAA/HLR, because such access can endanger the stability of their AAA/HLR.

There are a number of protocol solutions which have been developed for web-SSO, for example SAML and OpenID. SAML is an XML-based standard for exchanging authentication and authorization data between an identity provider and a service provider. SAML assumes the user has registered with the identity provider, which provides local authentication services to the principal even though SAML does not specify the implementation of these local services. OpenID is an open, decentralized standard for authenticating users in which a user registers an Open ID with an identity provider and sometime later visits a website termed the relying party, which is in the position of the SAML service provider. The relying party and the identity provider establish a shared secret, referenced by an associate handle, which the relying party stores. Typically, an OpenID identity provider prompts the user for a password or an InfoCard, then asks whether the user trusts the relying party web site to receive his credentials and identity details. If yes, the user's browser is redirected to the designated return page on the relying party web site along with the user's credentials.

Some implementations for interfacing terminal authentication of core networks with open Internet source fall under tradenames such as Liberty Alliance Project and RADIUS and/or DIAMETER servers of a mobile session manager concept. But still none are true web-SSO implementations which charge the mobile subscriber's home operating network account for purchases the subscriber makes on the Internet.

### SUMMARY

The foregoing and other problems are overcome, and other advantages are realized, by the use of the exemplary embodiments of this invention.

In a first aspect thereof the exemplary embodiments of this invention provide a method, comprising: receiving at an apparatus an initial credit control request from a relying party, the initial credit control request bearing first information comprising a relying party identifier, a service context identifier for a service to be provided by the relying party, and a token that authenticates a subscriber; and the apparatus extracting the first information and forwarding the extracted first information to a core network accounting server that stores account information for the subscriber, in which the relying party is not within the core network. Further in this exemplary method, the apparatus receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party; the apparatus extracting the second information and forwarding the extracted second information to the relying party.

In a second aspect thereof the exemplary embodiments of this invention provide an apparatus comprising at least one processor and a memory storing computer program code. The memory and the computer program code are configured, with the at least one processor, to cause the apparatus to perform at least the following. In response to receiving an initial credit control request from a relying party, the initial credit control request bearing first information comprising a relying party identifier, a service context identifier for a service to be provided by the relying party, and a token that authenticates a subscriber, what is performed is extracting the first information and forwarding the extracted first information to a core network accounting server that stores account information for the subscriber, in which the relying party is not within the core network. Further, in response to receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party, what is further preformed is extracting the second information and forwarding the extracted second information to the relying party.

In a third aspect thereof the exemplary embodiments of this invention provide a memory storing a program of computer readable instructions which when executed by at least one processor cause the at least one processor to perform actions comprising at least the following. In response to receiving an initial credit control request from a relying party, the initial credit control request bearing first information comprising a relying party identifier, a service context identifier for a service to be provided by the relying party, and a token that authenticates a subscriber, the actions comprise extracting the first information and forwarding the extracted first information to a core network accounting server that stores account information for the subscriber, in which the relying party is not within the core network. And further, in response to receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party, the actions further comprise extracting the second information and forwarding the extracted second information to the relying party.

### BRIEF DESCRIPTION OF THE DRAWINGS

FIG. 1 is a high level block diagram showing a user equipment, radio access network, core or mobile operator network and the Internet which forms the environment for certain exemplary embodiments of the invention.

FIGS. 2A-B are portions of the same signaling diagram showing message exchange between various entities shown at FIG. 1, according to an exemplary embodiment of the invention.

FIGS. 3A-C illustrate a web-service based CCR and CCA according to an exemplary embodiment of the invention.

FIG. 4 is a logic flow diagram that illustrates the operation of a method, and a result of execution of computer program instructions embodied on a computer readable memory, in accordance with the exemplary embodiments of this invention.

FIG. 5 is a schematic block diagram showing internal components of the relying party and certain nodes of the core network from FIG. 1, according to an exemplary embodiment of the invention.

### DETAILED DESCRIPTION

Exemplary embodiments of this invention combine benefits of identity management in the core network with accounting/fee-charging to re-use available infrastructure in a manner that allows the core network to interpose control mechanisms to protect their subscriber data. In an exemplary embodiment there is a mechanism for synchronizing a Web-Single-Sign-On (Web-SSO) session with an off-line accounting or real-time credit control session. The interaction with the existing AAA/HLR/HSS infrastructure, which provides the accounting, allows generic Internet Web-SSO solutions to utilize well-established cellular telecommunication infrastructure and available business agreements in a scalable fashion for service usage that requires charging.

Exemplary embodiments of the invention link the core network and the internet service providers RPs in a manner that simultaneously exploits advantages of both: the AAA infrastructure is used but is shielded from access by the Internet service providers, while at the same time the Internet service providers (for example, using SAML or OpenID) can authenticate customers/users with a Web-SSO approach.

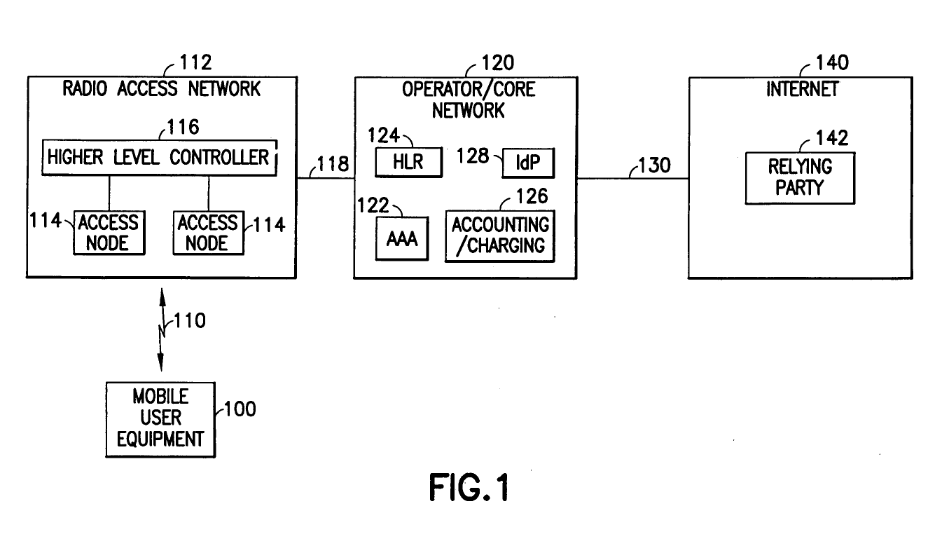

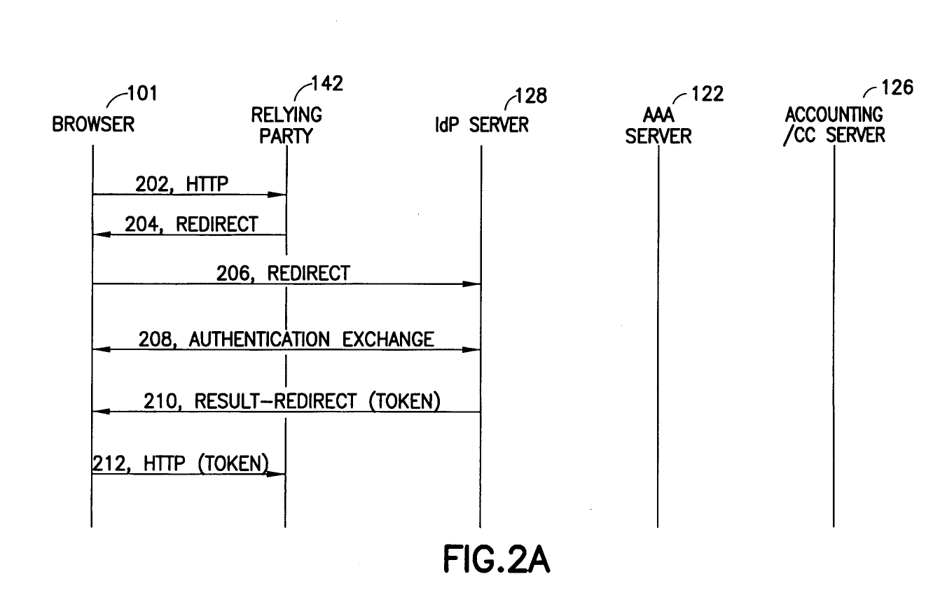

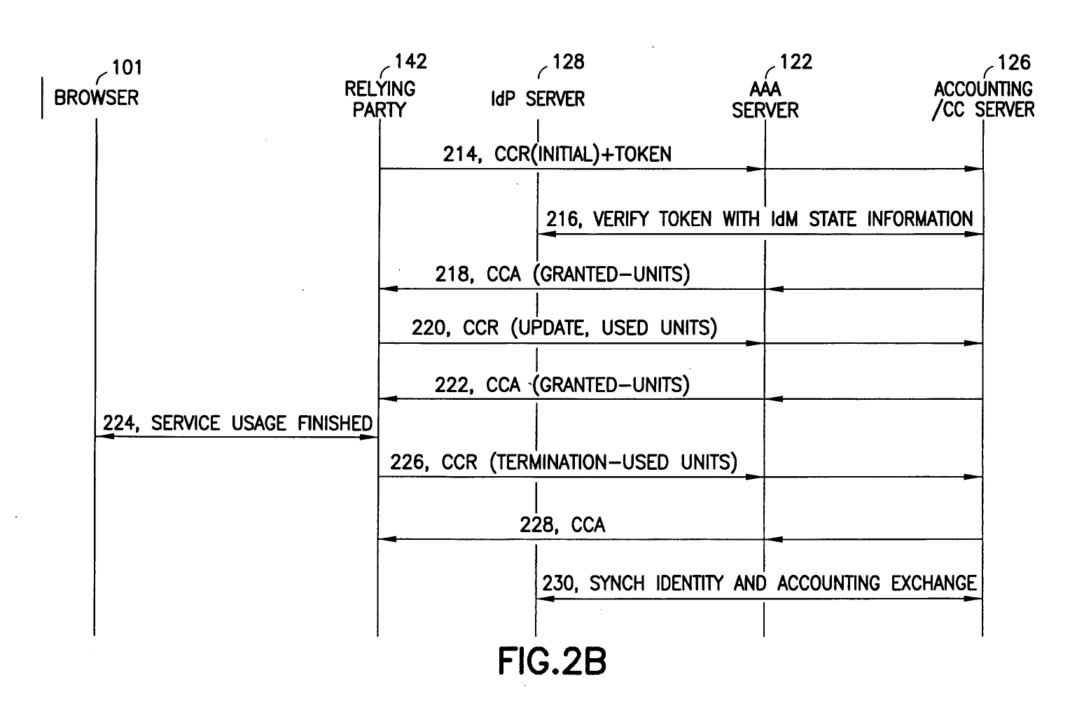

FIG. 1 is a schematic block diagram showing an environment in which exemplary embodiments of the invention can be practiced, and giving context to the specific nodes/devices set forth at the signaling diagram of FIGS. 2A-B. There is a mobile user equipment 100 which has a wireless connection 110 with a wireless mobile telecommunications network referred to as a RAN 112 which includes both access nodes 114 that directly communicate with the mobile user equipment 100, and possibly also higher level controllers 116 (such as for example radio network controllers or similar) which control several access nodes 114. The RAN 112 is operatively coupled via a data connection 118 to a core network 120, sometimes also termed a core network. The core network 120 has a data connection 130 to an external data network such as for example the Internet 140 and thereby provides the user equipment 100 with access to the Internet 140. The access node 114 has the wireless link directly with the user equipment 100. The RAN 112 provides connectively between the access node and either or both of an AAA server 122 and an HLR 124. By example this connectivity to the RAN 112 may be via a SGSN (serving GPRS supporting node, not shown) or similar functionality for other types of core networks. The core network 120 also provides connectivity with the external data networks/Internet 140. By example this connectivity to the external data network 140 may be via a GGSN (gateway GPRS supporting node, not shown) or similar functionality in other types of core networks. The operating network 120 is therefore the communications bridge between whatever RAN 112 the terminal 100 has access to and the external data network 140.

The core network 120 further has an accounting/charging server 126 which has stored an association between the user terminal's identifier (for example, its universal subscriber identifier USIM or similar permanent and unique identifier) and charging information for that user terminal (for example, subscriber billing information or charging account information). It is the accounting/charging server 126 that credits or debits the user's actual account to assure the relying party 142 is paid for the service it provides to the subscriber. Also controlled by the core network 120 is an identity provider IdP 128, which stores associations between the terminal's authenticated identifier (for example, that provided by the AAA node 122) and some temporary identifier (such as a session identifier) which more generic web servers use to identify customers transactionally. The IdP 126 is sometimes referred to as a mobile identity management node or function, or alternatively as a mobile session management node or function, because it provides authentication of the terminal 100 to the Internet-based service providers 142 without exposing to those Internet nodes the actual subscriber or charging/billing information that is maintained by the accounting/charging server 126. Debits and credits entered at the HLR 124 and/or the AAA 122 are bookkeeping entries; it is at the accounting/charging server 126 that the subscriber's actual funding sources (for example: debit minutes, credit card, monthly billing statement) are debited/credited. These and other security precautions prevent direct access to the user's USIM and its funding source by entities that are not trusted, generally those that are not part of the core network 120 or part of other core networks having a service level agreement with the host core network 120. The core network may also include one or more visiting location registers VLRs, not shown. It is understood that the core network 120 described in the message exchange below is the home core network of the user equipment 100.

The Internet 140 includes multiple service providing nodes which are termed herein the relying party RP 142. These are for example, servers which provide to individual users download of content such as audio or video clips, or access to some content that is restricted from free viewing by the public at large. In a particular but non-limiting embodiment the relying party 142 operates with a SAML or OpenID protocol for identifying the user, which in this case is the mobile user equipment 100. It is the relying party 142 (or similarly situated service providing node/website) which provides content to the user equipment 100 via download or access grant, regardless of the possibility that the content itself may actually be hosted by some other server. Communications between the user equipment 100 and the Internet 140/RP 142 pass through the core network 120.

FIGS. 2A-B represent a signaling diagram for a single session and showing message exchange between various of the nodes shown at FIG. 1 according to a particular embodiment of the invention. FIG. 2A illustrates generally the web single sign-on by which the terminal/user equipment 100 obtains access to the relying party 142 which used SAML OpenID or similar open-source message protocol for user authentication, and FIG. 1B illustrates generally the accounting process by which the subscriber's account information (which is stored in the core network 120 but not made available to the RP 142) is used to arrange payment for the content provided by the RP 142. At FIGS. 2A-B the user equipment 100 is represented as a browser 101 so as to more particularly show that the functionality in the user equipment 100 for implementing exemplary embodiment of the invention may lie wholly within the web browser software stored on a local memory of the user equipment 100. Pass through nodes for the messages of FIGS. 2A-B are not particularly shown.

It is assumed at the start of FIG. 2A that the user equipment 100 has already set up its communication link with the core network 120 via the access node 114 of the RAN 112. For the case of GSM or UMTS (including evolved-UTRAN), the user equipment is authenticated on connection setup using the subscriber information stored in the HLR 124 or AAA 122. The core network 120 itself is considered as a trusted source so the personal identification number PIN of the user equipment subscriber identity module SIM may be used for authentication on setup of the RAN's physical wireless link. For the case of WLAN the physical link setup is different and the WLAN cannot be considered to be trusted, and so additional information is needed to authenticate the user equipment for WLAN link setup. Also assumed in FIG. 2A is that the messages there are SAML, OpenID or similar open-ended message format protocols, meaning that additional data can be placed into prior art type messages which the nodes can already recognize and the nodes can still read the additional data. This makes implementation much simpler than re-defining message formats for all the nodes involved.

Message 202 of FIG. 2A is an initial request from the browser 101 to the RP 142 for some content or service that needs authentication. In an embodiment and as known in the art this request 202 uses secure HTTPS to contact the application in the RP 142, such as automatically by the user selecting some link or portal at a hosting or linking web page. The RP 142 selects a session ID or other temporary identifier, and responds at message 204 with a redirect response that includes an authentication request, some authentication of the user equipment 100 or its user on which the RP 142 can rely.

The browser 101 then closes the previous request/response transaction (messages 202 and 204), takes the information received in the redirect response 204 (for example, the session ID), and at message 206 sets up a new request to the IdP server 128. This request 206 may optionally include a non-persistent encrypted session cookie, set by a previous identification and authentication of the same browser 101.

Details of the resulting authentication exchange 208 are not shown particularly in FIG. 2A, but two distinct embodiments for a roundtrip authentication exchange 208 are now detailed. In a first embodiment of the authentication exchange 208, the IdP server 128 sends to the browser 101 a response with a confirmation page that the IdP server 128 has set up which contains information about the successful identification and authentication of the user equipment 100; and the browser 101 sends a confirmation request which the IdP server 128 interprets as a the subscriber's decision that it chooses to provide authentication to the RP 142. In a second embodiment the authentication exchange 208 is a multi-roundtrip authentication exchange, such as might lead to an exchange between the browser 101 and the IdP server 128 using a password or AKA exchange known in the art (for example, that detailed at 3GPP TS 33.220). The authentication exchange may be implemented in other alternative ways, but the end result is that the IdP server 128 is satisfied that the subscriber/browser 101 is in fact requesting that it be given an authentication to use with the RP 142.

As a result of the authentication exchange 208 the IdP server 128 generates a handle or token which it stores in its local memory for later use. This token may take any of several forms, such as for example a temporary username for the browser 101/user equipment 100 created by the IdP 128, a random value signed by the IdP server 128, or some other form of a cryptographic token. In an embodiment this token is base64 encoded. The IdP server 128 then sends to the browser 101 a redirect response 210 that includes a redirect to the RP 142 and the handle or token it generated. Once the browser 101 provides this token to the RP 142 at message 212, the webSSO process is complete. The user equipment 100 may also sign the token prior to placing it in message 212 to provide an assurance of non-repudiation to the RP 142. Alternatively the IdP server 128 can provide the token to the RP 142 directly via the Internet, since the IdP server 128 also has the IP address of the RP 142 via the browser's request within the authentication exchange 208. This does not necessarily mean the browser 101 will not also send the same token via message 212 to the same RP 142, since the RP 142 might require the non-repudiation aspect it gets from receiving a signed token from the browser 101 itself.

It is noted that each distinct session between the browser 101 and the RP 142 should be assigned a fresh and unique token to guard against replay attacks. In an embodiment, when a fresh token is desired then the browser 101 can engage in a new authentication exchange 210 to obtain a new token, or the RP 142 can redirect the browser 101 to the IdP 128 without the actual authentication request (for example, message 204 can have the redirect IP address but an empty authentication request). For the latter case the IdP server 128 can simply return a new token (to the browser 101 and alternatively also directly to the RP 142) since the user equipment 100 is already authenticated, and send the redirect message 210 with the new token to the browser 101.

Note that at this point of the above signaling implementation there is no association anywhere between the user equipment charging/billing information which is stored at nodes 122, 124, and/or 126 of the core network 120, and the token which was generated by the IdP 128 for the subscriber to use with the specific RP 142 that subscriber requested. The token is for use on the OpenID type Internet (though of course it might be restricted to HTTPS exchanges) since in general servers on the Internet are not considered by the core network 120 to be trusted nodes.

Now at FIG. 2B is shown exemplary signaling to implement the accounting procedure. These illustrate an AAA exchange embodiment using a traditional subscriber credit account in which the core network regularly invoices the subscriber. An exchange in which the subscriber was operating using a pre-paid account would lead to the messages at FIG. 2B to have a somewhat different message structure. The usage of prepaid (debit) or traditional (credit) accounting may in some specific embodiments represent a non-real time version of the exchange.

FIG. 2B begins with the RP 142 having the authenticating token from message 212 of FIG. 2A, and/or from the IdP server 128 directly. Before providing any fee-based service to the browser 101, the RP 142 seeks to assure that it will receive payment for it. The RP 142 sends an initial CCR 214 which also has the token to the browser's AAA server 122. In an embodiment, the token can for example be placed in the CCR fields Service-Parameter-Info field. The Auth-Application-Id could be utilized for the OpenID identifier which identifies the RP 142. The AAA server 122 forwards the information on to the accounting server 126, since no non-trusted source has access to the accounting server 126 due to security concerns. Since the CCR is received in the web protocol, the AAA server converts message 214 from web-protocol to core network protocol.

The accounting server 126 doe not yet recognize who is allocated the token, so at message 216 it verifies the token with the IdP server 128. The IdP server 128 has the identifier of the subscriber for both systems: the OpenID or SAML of the non-trusted Internet 140, and the SIM of the subscriber that it used to get its initial access to the core network 120 via the RAN 112. These two are related to one another in the memory of the IdP server 128 via the token. Once it gets verification of the token from the IdP server 128, the accounting server 126 stores the association of the token with the subscriber's billing information, and checks that there are sufficient credit or debit units available for that subscriber. In the case of a prepaid subscriber, the accounting server 126 might check to assure there is some threshold of available minutes left on the subscriber's pre-paid card. In the case of a traditional monthly-account subscriber, the accounting server 126 might check to assure there is no restrictions as to content delivery already on the account, such as those a subscriber might impose on him/herself (for example, a parent's monthly limit on their teenager's phone account).

At CCA message 218 the accounting server 126 informs the AAA server 122 that the requested download service or fee for that service is granted. In an embodiment shown at FIG. 2B the accounting server 126 grants a finite number of units to which the subscriber is bound, and these units may be in terms of download minutes for the case of prepaid subscribers or may be in terms of currency units (for example, dollars or euros) for the case of currency prepaid subscribers or traditional subscribers with a credit account at the accounting server 126. Regardless, the AAA server 122 forwards the information to the RP 142. Since the CCA is received in the core network protocol, the AAA server converts message 218 from core network protocol to web protocol. The RP 142 receives that web-protocol message 218 and is now assured of payment for up to the granted number of units, and so provides the download or fee-based service to the browser 101/user equipment 100.

Messages 220 and 222 assume there is a need to authorize additional units, either because the service which the browser 101 requested exceeds the number of units granted by CCA message 218 or because the browser 101 is requesting further downloads/services beyond the initial request 202. CCR message 220 is an update request, which in an embodiment also stipulates the number of units that have been used from the original grant at CCA message 218. This is so the accounting server 126 can, for example, consider any un-used units from the original grant when deciding on any further grants for this same subscriber. The RP 142 sends the CCR message 220 to the AAA server 122 which forwards it (after changing the message protocol) to the accounting server 126. Since this is an update CCR rather than an initial CCR there is no need for the accounting server 126 to verify with the IdP server 128. The accounting server 128 sends a new CCR grant message 222 to the AA server 122 which again forwards it after changing message protocol to the RP 142.

Messages 220 and 222 may continue as needed for the services which the subscriber requests or until the accounting server 126 denies further unit grants. The entirety of the services provided by the RP 142 to the browser 101 are shown at message exchange 224, but it may be that partial services are provided after the RP 142 receives message 218 and message 224 only represent the conclusion of the service provisioning. In any case, once the services to the browser 101 are complete the RP 142 sends a CCR termination message to the AAA server 122 which tells the number of units that were used for the download or other services. If there was an earlier message 220 with used units, the total is accounted for among all such messages without double counting. The AAA server 122 forwards the information of this termination CCR message 226 to the accounting server 126 which prepares to credit or debit the subscriber's funding source for the full amount of used units. Finally at message 230 the accounting server 126 synchronizes the identity of the browser 101 with the IdP server 128, and there may also be come accounting exchange as to number of used units. This enables the IdP server 128 to delete the generated token for the session which completed after exchange 224.

In summary then, the SAML/OpenID IdP 128 (via the UE 100/browser 101 or alternatively directly) delivers to the Relying Party 142 (or to an alias service provider such as a search engine or web crawler page) an authorization handle, only in the case of a successful single-sign-on protocol execution. SAML and OpenID can convey such an authorization from the IdP 128 to the RP 142 in a protected way, including confidentiality protection, such as for example via linked HTTPS addresses. The IdP server 128 stores this authorization handle. These aspects of the overall process flow are shown at FIG. 2A.

The authorization handle is forwarded by the RP 142 in the subsequent AAA exchange (accounting/credit control exchange) to allow the accounting server 126 to prove that a successful authentication exchange has happened and also to allow the two exchanges/networks to be linked together. The usage of the existing AAA infrastructure allows existing charging mechanisms to be utilized. The message routing through the AAA infrastructure mimics business agreements. These aspects of the overall process flow are shown at FIG. 2B.

The accounting messages at FIG. 2B contain the previously provided handle/token with them in order to allow the correlation of the Internet exchange with the core network exchange. In message 216 the initial verification takes place to ensure that the later accounting messages do not withdraw money from a customer account without a previously successful authentication exchange. Note that the authentication exchange 208 (FIG. 2A) might have also come with a dialog between the user and the IdP 218 about the amount of granted information (i.e. an authorization dialog), so that the user must personally enter some approval rather than an automated process whose only financial limit may be that of subscriber's account itself.

Additionally, the user equipment 100 might be provided with (part of) charging information together with a device certificate. The browser 101 would then use the device certificate to sign the token it sends in message 212, and such a device certificate and signing might be done in secure hardware in the user equipment 100. The charging information may be displayed to the user so the user can see the total amount of charges expected before the download begins, and possibly impose some limit of his/her own, which could be enforced by the IdP server 128 and by the accounting server 126. In an embodiment information about the charging and other types of restrictions can be encapsulated in a protected token, which protects it against modifications by the user or other parties by integrity and replay protection for example. Alternatively, the exchange 216 between the accounting server 126 and the IdP server 128 can carry this information as well.

There are various approaches in the prior art for authenticating a mobile user equipment for accessing Internet based services, which may require some modification to the above example signaling exchange to fit with those other implementations. For example, some approaches use an AAA authentication exchange between the RP 142 and the AAA server 122, and eliminating it so as to implement these teachings could in certain examples lead to problems with the policy handling currently in use by those prior art approaches. To avoid such problems a dummy AAA authentication exchange can be used before the prior art credit control exchange. Instead of using the user's true identity and password, which the RP 142 would be using in a WebSSO solution according to certain prior art techniques but which for security purposes the RP 142 should not possess, the identity provided during the WebSSO exchange is re-used and the authorization handle is utilized as a replacement for a one-time password. The advantage of this procedure is that existing AAA protocol functionality can be used, though the dummy AAA authentication exchange represents the disadvantage of an additional protocol exchange being required.

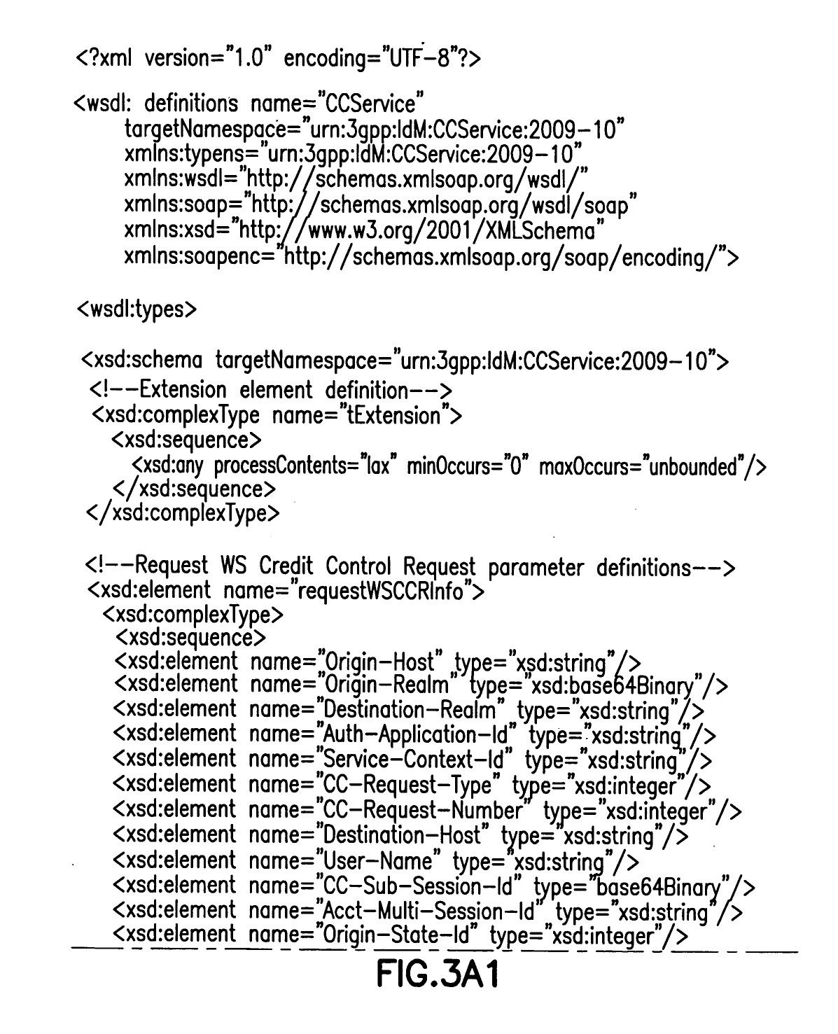

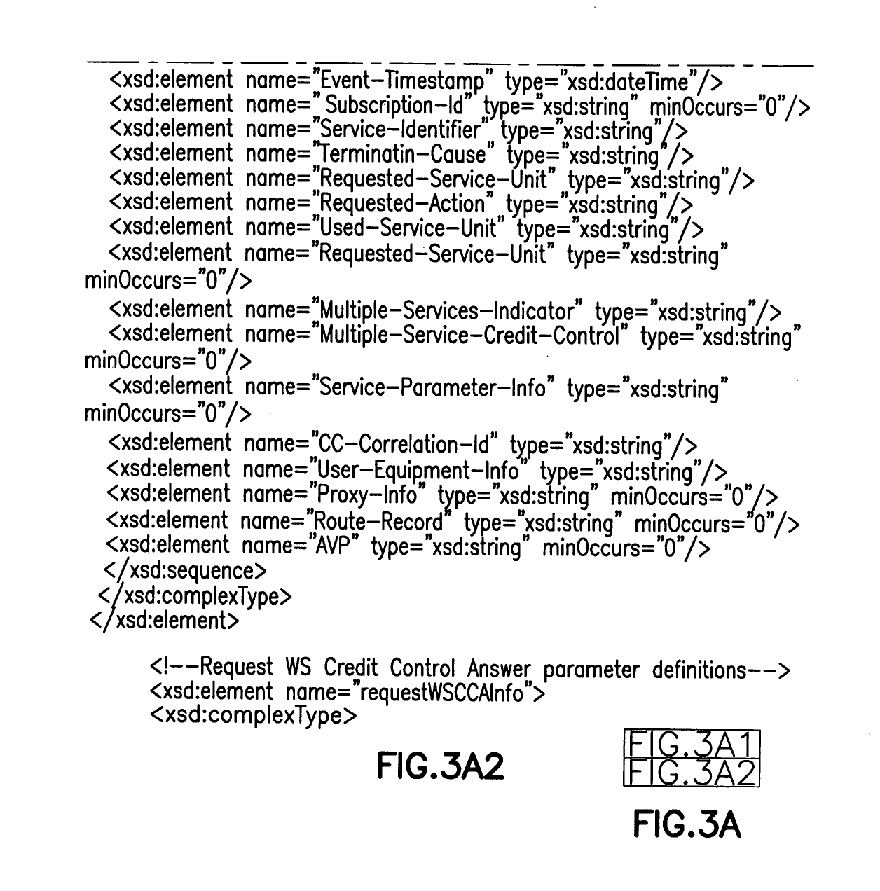

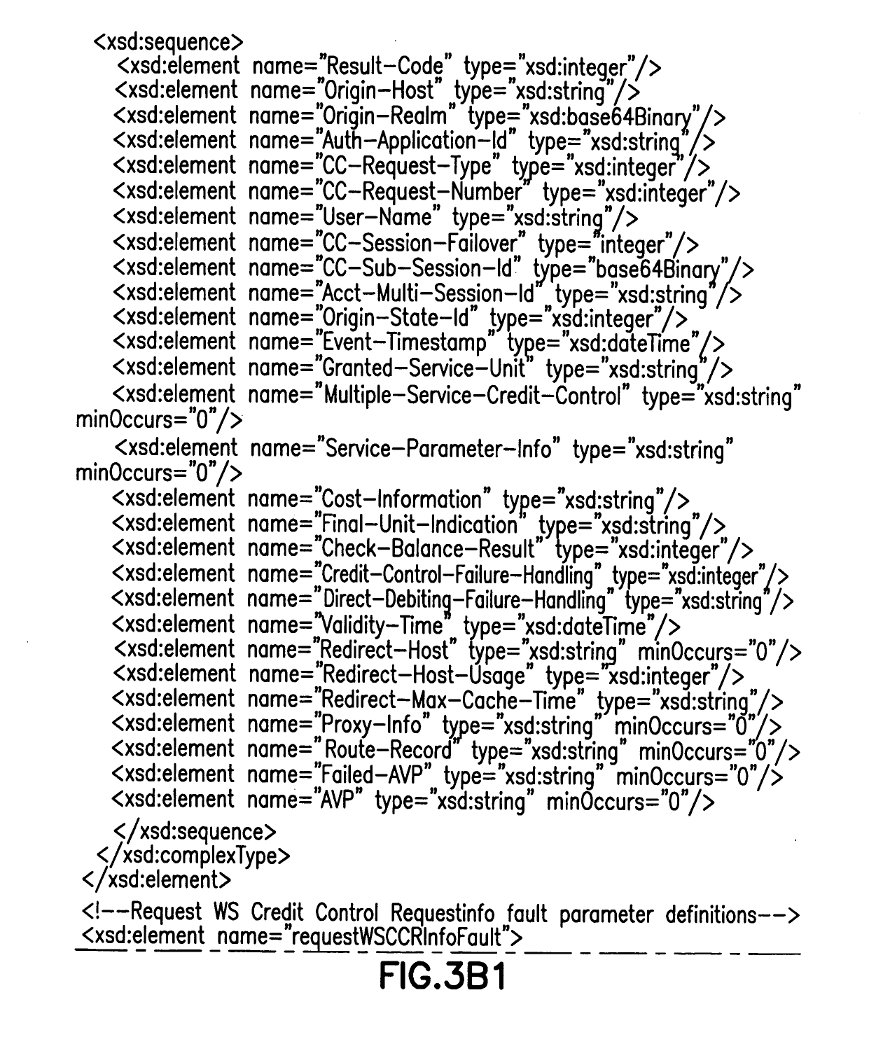

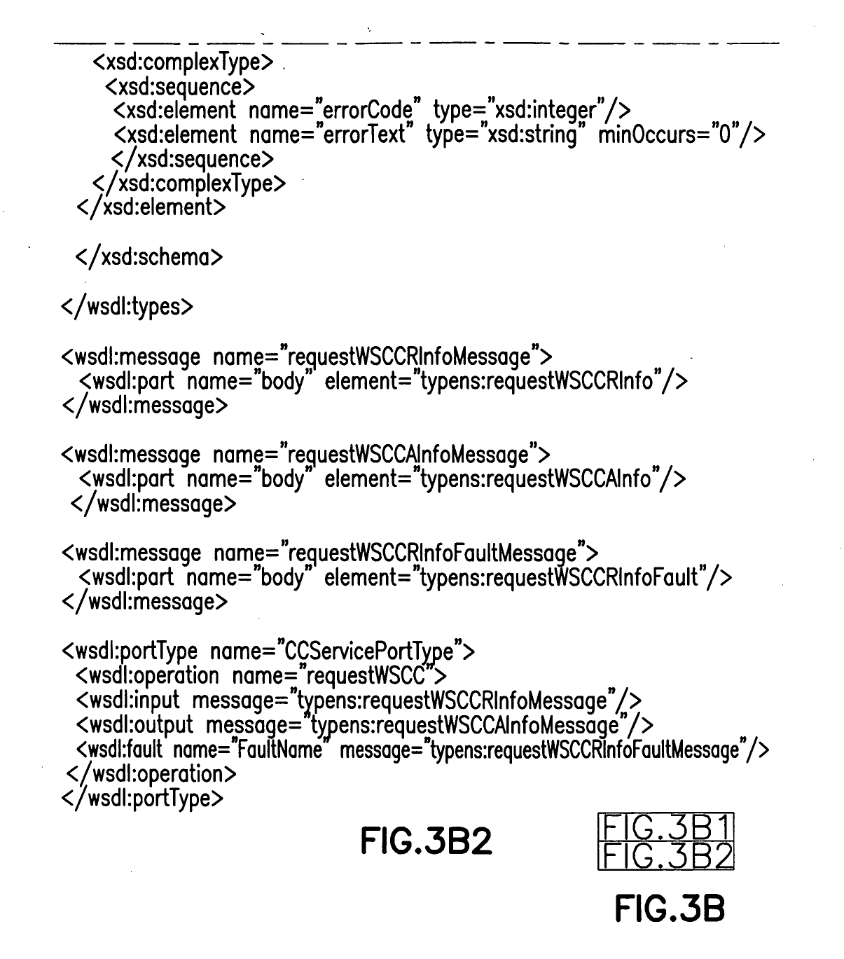

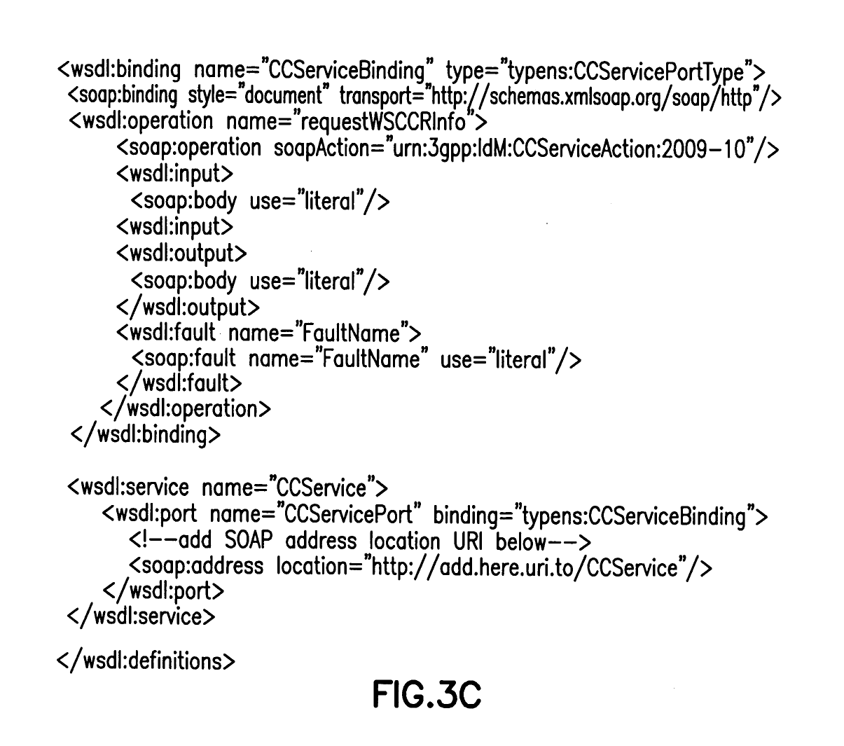

If in other implementations the RP 142 does not want to support certain prior art charging techniques and the underlying protocols, then the web services could be used between the RP 142 and a protocol translation AAA broker and then this AAA broker actually creates the accounting/credit control messages towards the AAA infrastructure. The RP 142 would in this variation send the same information in the body of a web service message, rather than in the CCA and CCR messages detailed at FIG. 2B. Such a web service message body is shown by specific example at FIGS. 3A-C, which represents a web-service based CCR and CCA.

In the web-service based CCR and CCA, the intermediate node between the core network 120 and the RP 142 is the AAA broker, and the AAA server 122 is in the same functional position between networks for the embodiment of FIG. 2B. Without loss of generality, consider this node to be a protocol conversion node, since as noted above it converts the CCR messages from the web protocol to the core network protocol and converts the CCA messages from the core network protocol to the web protocol.

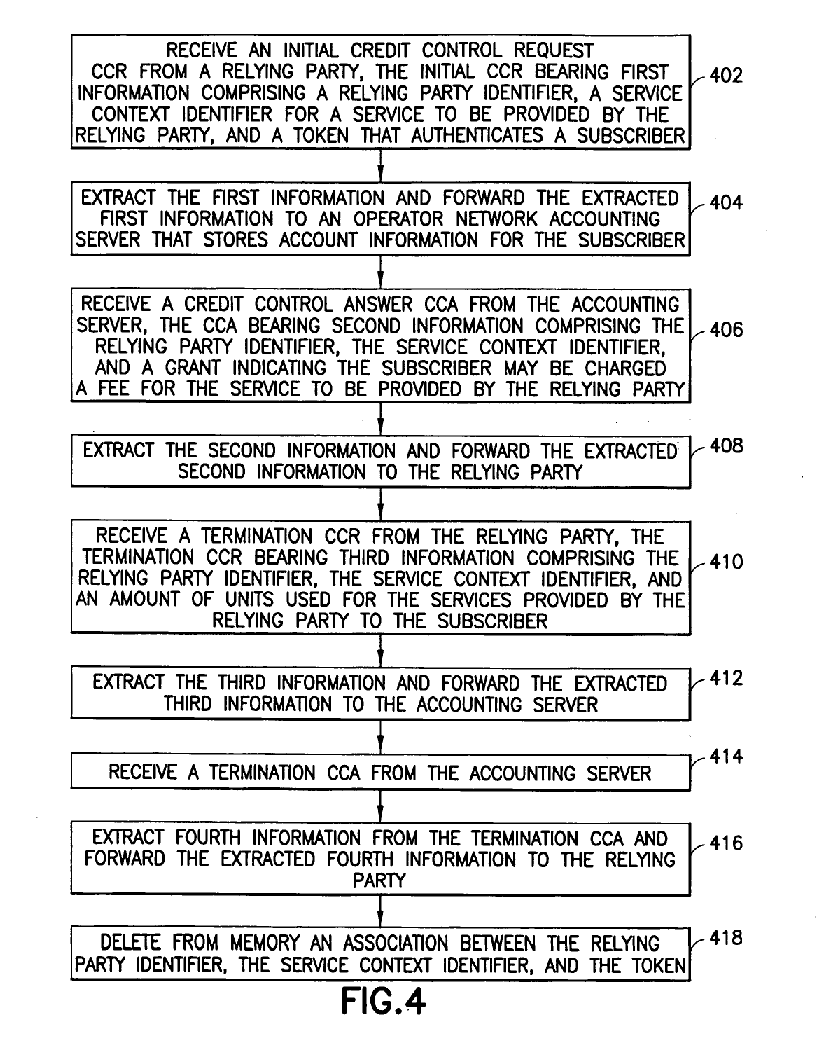

An exemplary embodiment of the invention may then be described from the perspective of that protocol conversion node, and is shown at FIG. 4. The protocol conversion node receives at block 402 an initial credit control request CCR from a relying party, the initial CCR bearing first information comprising a relying party identifier, a service context identifier for a service to be provided by the relying party, and a token that authenticates a subscriber. At block 404 the AAA node extracts the first information and forwards the extracted first information to a core network accounting server that stores account information for the subscriber. The relying party is not within the core network. At block 406 in reply to forwarding the extracted first information, the node receives a credit control answer CCA from the accounting server, the CCA bearing second information comprising the relying party identifier, the service context identifier, and a grant indicating the subscriber may be charged a fee for the service to be provided by the relying party. And at block 408 the node extracts the second information and forwards the extracted second information to the relying party.

The above described portion of FIG. 4 matches with the AAA server's functions regarding messages 214 and 218, in which the initial CCR 214 is received in a first message protocol (web message protocol) and the extracted first information is forwarded in a second message protocol (core network message protocol).

As noted at FIG. 2A and message 210, the token is generated by an identity provider node 128 of the core network 120, and that token may be base64 encoded. Also noted above the initial CCR (the first information at block 402 of FIG. 4) may also include a device certificate for the subscriber, which may also be signed by the subscriber for non-repudiation.

Further at FIG. 4 are process blocks for the termination CCR messages of FIG. 2B. At block 410, after forwarding the extracted second information to the relying party, the AAA node receives a termination CCR from the relying party. The termination CCR bears third information comprising the relying party identifier, the service context identifier, and an amount of units used for the services provided by the relying party to the subscriber. At block 412 the node extracts the third information and forwards the extracted third information to the accounting server.

Then at block 414, in reply to forwarding the extracted third information, the AAA node receives a termination credit control answer CCA from the accounting server. At block 416 the AAA node extracts fourth information from the termination credit control answer CCA and forwards that extracted fourth information to the relying party. These represent the termination CCA at message 228 of FIG. 2B. Then at block 418 the AAA node deletes from its local memory an association between the relying party identifier, the service context identifier, and the token, since at this point the service provided by the RP 142 is terminated as indicated by block 410.

The various blocks shown in FIG. 4 may be viewed as method steps, and/or as operations that result from execution of computer program code, and/or as a plurality of coupled logic circuit elements constructed to carry out the associated function(s).

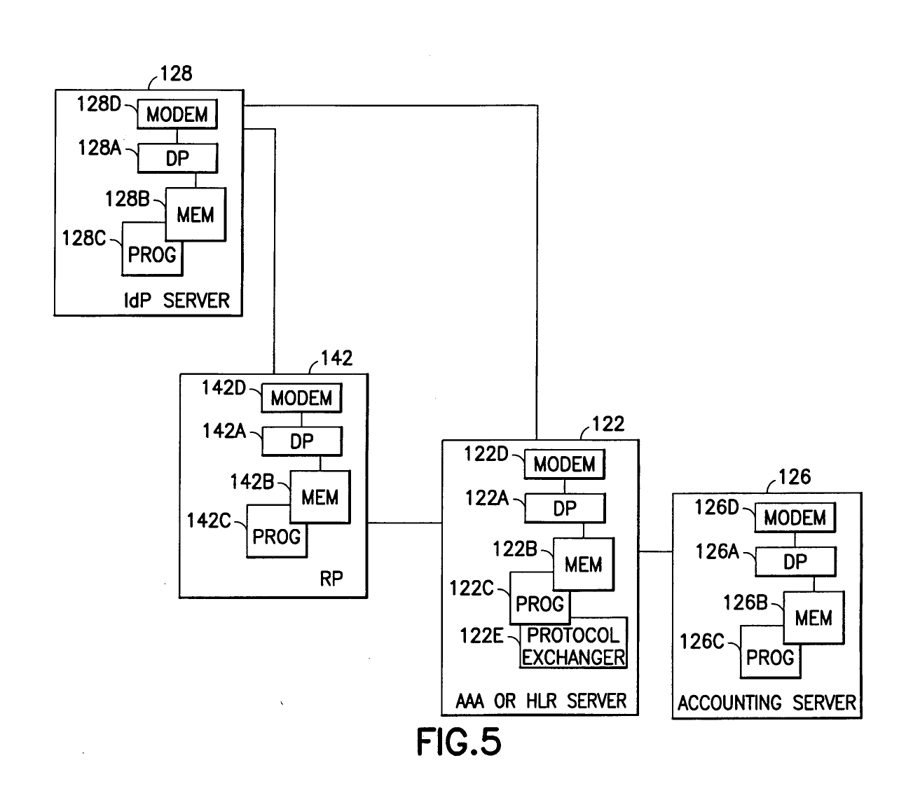

FIG. 5 is a schematic block diagram showing further detail of a relying party and certain nodes of the core network which were shown at FIG. 1. These are exemplary and there may be various other ways in which these nodes are constructed and operate. Note that at FIG. 5 the AAA server 122 is denoted AAA or HLR server; this implies that the HLR server may operate as detailed above with respect to FIGS. 2A-B and 4 for the AAA server, but the core network 120 may or may not have separate nodes/servers for these two functions. Note also that only the AAA or HLR node 122 has access to the accounting server 126. At FIG. 5, each node illustrated is within the core network 120 except the RP 142. For the case that there is an AAA broker in a particular embodiment, such an AAA broker node is in the position of the illustrated AAA server 122 but does not have direct access to the subscriber charging information stored in the accounting server 126; there generally would be another core network node interposed between them in an exemplary embodiment.

The core network 120 is adapted for communication via a wireless radio access network 112 (see FIG. 1) with an apparatus, such as a mobile communication device which may be referred to as a UE 100. The wireless link 110 of FIG. 1 may be between the UE 100 and a network access node such as a Node B (base station), eNode B, access point, or the like for various different types of RANs. The RAN 112 may include a network control element (NCE) 116 (see FIG. 1) that may include mobility management and/or serving gateway functionality and which provides connectivity with a core network 120, which then provides connectivity to an external data network such as a telephone network and/or a data communications network (e.g., the internet). Such connectivity is shown at FIG. 1 as being through the IdP server 128 since that is how the signaling diagram of FIGS. 2A-B flows, but such signaling is not limited to how the core network 120 connects to the Internet generally.

The nodes of FIG. 5 are denoted as servers for clarity of description, though in exemplary embodiments they may not be stand-alone servers but rather are components of other nodes which combine the described functions with other functionality.

The IdP server 128, AAA and/or HLR server 122, accounting server 126, and relying party server 142, each include the following: a respective computer or data processor (DP) 128A, 122A, 126A and 142A; a respective computer readable storage medium embodied as a memory (MEM) 128B, 122B, 126B and 142B; a respective program of computer instructions (PROG) 128C, 122C, 126C and 142C that is stored on the MEM; and a respective modem 128D, 122D, 126D and 142D. These nodes communicate with one another across the illustrated data paths as detailed by example at FIGS. 2A-B.

Note that the AAA or HLR server 122 further includes a protocol exchanger 122E according to the above teachings, which extract information from a received message which has a first message protocol and put the extracted information in another message for sending, the another message having a second protocol. The protocol exchanger 122E may be embodied as software (a PROG 122C) stored on the MEM 122B and executable by the DP 122A, as hardware (circuitry in the DP 122A or a similar application-specific circuit), or as some combination of hardware and software.

One or more of the other PROGs 128C, 126C and 142C is assumed to include program instructions that, when executed by the associated DP, enable the node/device to operate in accordance with the exemplary embodiments of this invention, as discussed above in greater detail. As with the AAA or HLR server 122, these exemplary embodiments of this invention implemented in the other nodes may be implemented at least in part by computer software executable by the DP of the respective node, or by hardware, or by a combination of software and hardware (and firmware).

The computer readable MEMs 128B, 122B, 126B and 142B may be of any type suitable to the local technical environment and may be implemented using any suitable data storage technology, such as semiconductor based memory devices, flash memory, magnetic memory devices and systems, optical memory devices and systems, fixed memory and removable memory. The DPs 128A, 122A, 126A and 142A may be of any type suitable to the local technical environment, and may include one or more of general purpose computers, special purpose computers, microprocessors, digital signal processors (DSPs) and processors based on a multicore processor architecture, as non-limiting examples. The illustrated DPs may represent a single processor or multiple processors coupled to one another and operating under direction of one master processor.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or signaling diagrams, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

We claim:

1. A method, comprising:
receiving at an apparatus an initial credit control request from a relying party, the initial credit control request bearing first information comprising a relying party identifier, a service context identifier for a service to be provided by the relying party, and a token that authenticates a subscriber;
the apparatus extracting the first information and forwarding the extracted first information to a core network accounting server that stores account information for the subscriber, in which the relying party is not within the core network;
the apparatus receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party; and
the apparatus extracting the second information and forwarding the extracted second information to the relying party.

2. The method according to claim 1, in which the apparatus comprises a protocol conversion node that comprises one of an authentication, authorizing and accounting AAA node of the core network or an AAA broker node or a home location register HLR node;
and in which the initial credit control request is received in a first message protocol and the extracted first information is forwarded in a second message protocol.

3. The method according to claim 1, in which the token is generated by an identity provider node of the core network, and is base 64 encoded.

4. The method according to claim 1, in which the first information further comprises a device certificate for the subscriber.

5. The method according to claim 4, in which the device certificate is signed by the subscriber.

6. The method according to claim 1, the method further comprising, after forwarding the extracted second information to the relying party:
the apparatus receiving a termination credit control request from the relying party, the termination credit control request bearing third information comprising the relying party identifier, the service context identifier, and an amount of units used for the services provided by the relying party to the subscriber; and
the apparatus extracting the third information and forwarding the extracted third information to the accounting server.

7. The method according to claim 6, the method further comprising, in reply to forwarding the extracted third information:
the apparatus receiving a termination credit control answer from the accounting server;
the apparatus extracting fourth information from the termination credit control answer, forwarding the extracted fourth information to the relying party, and deleting from a memory of the apparatus an association between the relying party identifier, the service context identifier, and the token.

8. An apparatus comprising:
at least one processor;
memory storing computer program code;
in which the memory and the computer program code are configured, with the at least one processor, to cause the apparatus to perform:
in response to receiving an initial credit control request from a relying party, the initial credit control request bearing first information comprising a relying party identifier, a service context identifier for a service to be provided by the relying party, and a token that authenticates a subscriber, extracting the first information and forwarding the extracted first information to a core network accounting server that stores account information for the subscriber, in which the relying party is not within the core network; and
in response to receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party, extracting the second information and forwarding the extracted second information to the relying party.

9. The apparatus according to claim 8, in which the apparatus comprises a protocol conversion node that comprises one of an authentication, authorizing and accounting AAA node of the core network or an AAA broker node or a home location register HLR node;
and in which the initial credit control request is received in a first message protocol and the extracted first information is forwarded in a second message protocol.

10. The apparatus according to claim 8, in which the token is generated by an identity provider node of the core network, and is base 64 encoded.

11. The apparatus according to claim 8, in which the first information further comprises a device certificate for the subscriber.

12. The apparatus according to claim 11, in which the device certificate is signed by the subscriber.

13. The apparatus according to claim 8, in which the memory and the computer program code are configured with the at least one processor to cause the apparatus to further perform, after forwarding the extracted second information to the relying party:
in response to receiving a termination credit control request from the relying party, the termination credit control request bearing third information comprising the relying party identifier, the service context identifier, and an amount of units used for the services provided by the relying party to the subscriber, extracting the third information and forwarding the extracted third information to the accounting server.

14. The apparatus according to claim 13, in which the memory and the computer program code are configured with the at least one processor to cause the apparatus to further perform:
in response to receiving a termination credit control answer from the accounting server, said termination credit control answer being received in reply to forwarding the extracted third information, extracting fourth information from the termination credit control answer, forwarding the extracted fourth information to the relying party, and deleting from a memory of the apparatus an association between the relying party identifier, the service context identifier, and the token.

15. A memory storing a program of computer readable instructions which when executed by at least one processor cause the at least one processor to perform actions comprising:
in response to receiving an initial credit control request from a relying party, the initial credit control request bearing first information comprising a relying party identifier, a service context identifier for a service to be provided by the relying party, and a token that authenticates a subscriber, extracting the first information and forwarding the extracted first information to a core network accounting server that stores account information for the subscriber, in which the relying party is not within the core network; and
in response to receiving a credit control answer from the accounting server in reply to forwarding the extracted first information, the credit control answer bearing second information comprising the relying party identifier, the service context identifier, and a grant indicating the subscriber may be charged a fee for the service to be provided by the relying party, extracting the second information and forwarding the extracted second information to the relying party.

16. The memory according to claim 15, in which the token is generated by an identity provider node of the core network, and is base 64 encoded.

17. The memory according to claim 15, in which the first information further comprises a device certificate for the subscriber.

18. The memory according to claim 17, in which the device certificate is signed by the subscriber.

19. The memory according to claim 15, the actions further comprising, after forwarding the extracted second information to the relying party:
in response to receiving a termination credit control request from the relying party, the termination credit control request bearing third information comprising the relying party identifier, the service context identifier, and an amount of units used for the services provided by the relying party to the subscriber, extracting the third information and forwarding the extracted third information to the accounting server.

20. The memory according to claim 19, the actions further comprising, in reply to forwarding the extracted third information:
in response to receiving a termination credit control answer from the accounting server, said termination credit control answer being received in reply to forwarding the extracted third information, extracting fourth information from the termination credit control answer, forwarding the extracted fourth information to the relying party, and deleting from a memory of the apparatus an association between the relying party identifier, the service context identifier, and the token.
